(19) United States
(12) Patent Application Publication
(10) Pub. No.: US 2020/0030955 A1
(43) Pub. Date: Jan. 30, 2020

(54) DRIVING-IN DEVICE

(71) Applicant: HILTI AKTIENGESELLSCHAFT, Schaan (LI)

(72) Inventors: Emanuel KURTH, Chur (CH); Mario GRAZIOLI, Chur (CH); Joerg STAMM, Sennwald (CH); Daniel SCHWAB, Chur (CH); Iwan WOLF, Untervaz (CH)

(21) Appl. No.: 16/483,628

(22) PCT Filed: Mar. 19, 2018
(86) PCT No.: PCT/EP2018/056804

§ 371 Date: Aug. 5, 2019

(30) Foreign Application Priority Data
Mar. 20, 2017 (EP) 17161824.2

(51) Int. Cl. B25C 7/00; B25C 1/06

(52) U.S. Cl. CPC B25C 7/00; B25C 1/06

(57) ABSTRACT

A hand-held tool comprises a housing with a neck-like housing portion and a suspension element with a connection portion for connecting the suspension element to the neck-like housing portion and with a suspension portion for temporarily suspending the tool on a separate object, wherein the connection portion has two spring arms, which enclose the neck-like housing portion on opposite sides in a snap-fit connection in order to connect the suspension element to the housing.

### TECHNICAL FIELD

The application relates to a hand-held tool comprising a housing and a suspension element.

### PRIOR ART

Hand-held tools usually have a housing. Furthermore, suspension elements are known which are fastened to a hand-held tool in order to suspend the tool on a separate object such as a belt or scaffolding. The suspension then includes, for example, a hook for hooking into the belt or into a pole of the scaffold.

### DESCRIPTION OF THE INVENTION

According to one aspect of the application, a hand-held tool comprises a housing having a neck-like housing portion and a suspension element having a connection portion for connecting the suspension element to the neck-like housing portion and having a suspension portion for temporarily suspending the tool on a separate object, the connection portion having two spring arms, which enclose the neck-like housing portion on opposite sides in the manner of a snap-fit connection in order to connect the suspension element to the housing. The spring arms can preferably be resiliently spread apart.

An advantageous embodiment is characterized in that at least one of the two spring arms has a snap-fit lug which engages behind the neck-like housing portion in order to produce the snap-fit connection. Preferably, the snap-fit lug is arranged on an end of the at least one spring arm pointing away from the suspension portion.

An advantageous embodiment is characterized in that the neck-like housing portion has a circumferential surface which defines a pivot axis, the suspension element being connected to the housing so as to be able to pivot about the pivot axis.

An advantageous embodiment is characterized in that the neck-like housing portion has a latching recess, at least one of the two spring arms having a latching cam which engages in the latching recess in order to latch the suspension element in a pivot position about the pivot axis.

An advantageous embodiment is characterized in that an engagement depth of the latching cam in the latching recess is smaller than a rear engagement depth of the snap-fit lug behind the neck-like housing portion. This ensures that the suspension element is connected to the neck-like housing portion by means of the snap-fit lug while the suspension element is pivoted about the pivot axis.

An advantageous embodiment is characterized in that the neck-like housing portion has a plurality of latching recesses into which the latching cam engages in different pivot positions of the suspension element about the pivot axis.

An advantageous embodiment is characterized in that the suspension element consists substantially of a plastics material. With a suitable geometry, the spring arms are then sufficiently resilient but the suspension element as a whole is rigid enough to bear the tool.

An advantageous embodiment is characterized in that the housing has a connecting region for an electrochemical accumulator, and in that the connecting region for the electrochemical accumulator directly adjoins the neck-like housing portion.

An advantageous embodiment is characterized in that the housing has a handle around which the fingers of one hand can grip, and in that the handle includes the neck-like housing portion or directly adjoins the neck-like housing portion.

The neck-like housing portion is preferably arranged between the handle and the connecting region for the electrochemical accumulator.

An advantageous embodiment is characterized in that the tool is a nail gun.

### EMBODIMENTS

Embodiments of a hand-held tool will be explained in more detail in the following by way of examples with reference to the drawings, in which:

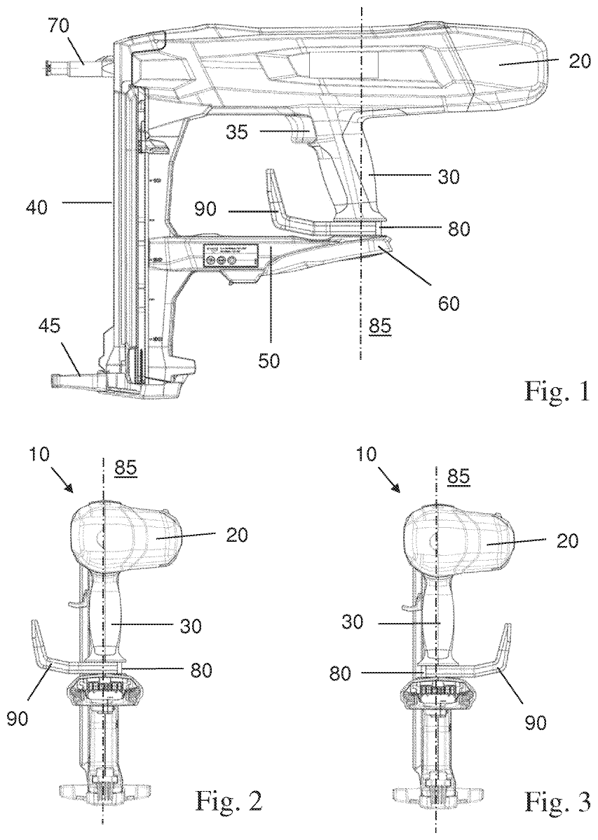

FIG. 1 is a side view of a hand-held tool;

FIG. 2 is a rear view of a hand-held tool;

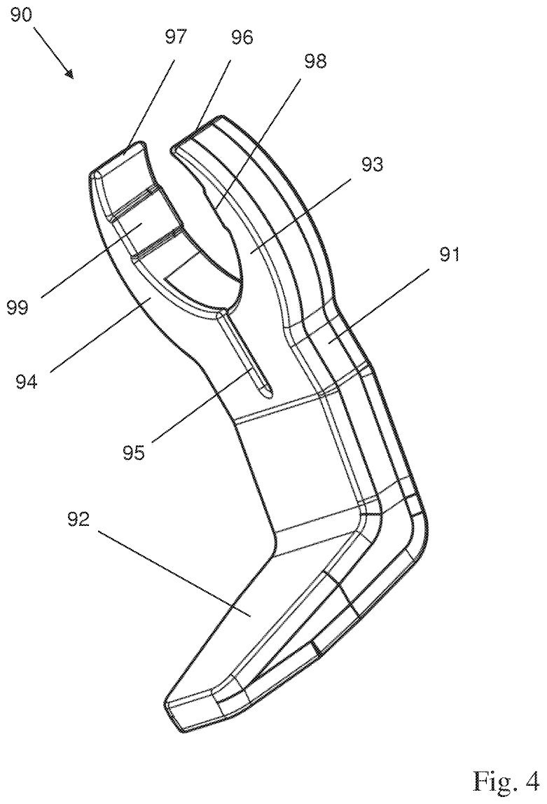

FIG. 3 is a rear view of a hand-held tool;

FIG. 4 is an oblique view of a suspension element;

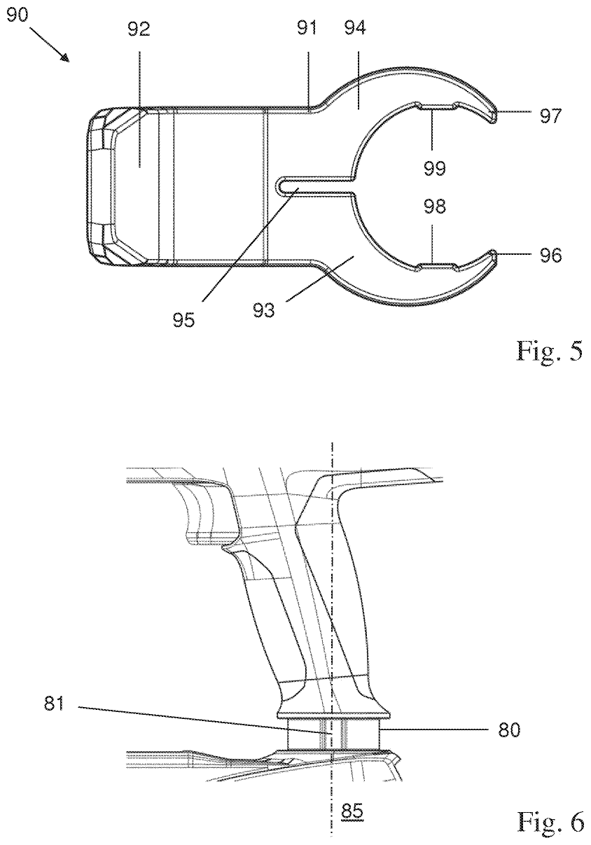

FIG. 5 is a plan view of a suspension element; and

FIG. 6 is a partial view of a hand-held tool.

FIG. 1 is a side view of a hand-held tool 10 designed as a nail gun for placing a fastening element, for example a nail or bolt, into a base. The tool 10 comprises an energy transfer element (not shown) for transferring energy to the fastening element and a housing 20 in which the energy transfer element and a drive means (likewise not shown) for moving the energy transfer element are accommodated.

The tool 10 further comprises a handle 30 around which the fingers of one hand can grip, a magazine 40, and a bridge 50 connecting the handle 30 to the magazine 40. The magazine is non-removable. A connecting region 60 for an electrochemical energy accumulator (not shown), for example a battery, is arranged on the bridge 50. A trigger 35 for manually triggering the placement of a fastening element is arranged on the handle 30. Furthermore, the tool 10 has a guide channel 70 for guiding the fastening element. Alignment of the tool 10 perpendicular to a base is facilitated by an alignment aid 45.

The housing 20 includes a neck-like housing portion 80 which is arranged between the handle 30 and the connecting region 60 for the electrochemical accumulator and to which the handle 30 directly connects at one end and the connecting region 60 directly connects at the other end. A suspension element 90, which is suitable for temporarily suspending the tool 10 on a separate object such as a belt or a scaffolding pole, is connected to the housing 20 at the neck-like housing portion 80.

A circumferential surface of the neck-like housing portion 80, which is largely concealed in FIG. 1 by the suspension element 90, preferably has the shape of a circular cylinder jacket and defines a pivot axis 85 about which the suspension element 90 is connected to the housing 20 so as to be able to pivot between different pivot positions. In an inoperative state, which is shown in FIG. 1, the suspension element 90 is substantially completely within a volume spanned by the housing 20 such that the suspension element 90 does not interfere with working with the tool 10.

FIG. 2 shows the tool 10 in which the suspension element 90 is pivoted from the inoperative state to the left by an angle of 90° about the pivot axis 85. In this left pivot position, the suspension element 90 is preferably suitable as a belt hook for right-handed people or as a scaffold hook for left-handed people.

FIG. 3 shows the tool 10 in which the suspension element 90 is pivoted from the inoperative state to the right by an angle of 90° about the pivot axis 85. In this right pivot position, the suspension element 90 is preferably suitable as a belt hook for left-handed people or as a scaffold hook for right-handed people.

FIG. 4 is an oblique view of the suspension element 90. The suspension element 90 includes a connection portion 91 for connecting the suspension element 90 to the neck-like housing portion 80 and a suspension portion 92 formed as a hook. The connection portion 91 has two spring arms 93, 94, which enclose the neck-like housing portion 80 on opposite sides in the manner of a snap-fit connection in order to connect the suspension element 90 to the housing 20. The connection portion 91 has a notch 95 in order to facilitate spreading apart of the spring arms 93, 94 and thus attachment of the suspension element 90 onto the neck-like housing portion 80.

The connection portion 91 and the suspension portion 92 are integrally formed, i.e. consist of a single element, and made of a plastics material such that the suspension element 90 consists substantially of a plastics material. In the present geometry, the spring arms 93, 94 are thus sufficiently resilient but the suspension element 90 as a whole is rigid enough to bear the tool 10. The suspension element 90 is connected to the housing 20 without further fastening elements such as screws and can be manually removed from the housing 20 without the use of tools.

FIG. 5 is a plan view of the suspension element 90. Each of the two spring arms 93, 94 comprises, at an end of the particular spring arm pointing away from the suspension portion 92, a snap-fit lug 96, 97 which engages behind the neck-like housing portion 80 with a rear engagement depth in order to produce the snap-fit connection. Furthermore, each of the two spring arms 93, 94 comprises a latching cam 98, 99 which is provided to engage in a latching recess 81, formed as a depression, of the neck-like housing portion 80 with an engagement depth, in order to latch the suspension element 90 in a pivot position about the pivot axis. The engagement depth of the latching cams 98, 99 in the latching recess 81 is smaller than the rear engagement depth of the snap-fit lugs 96, 97 behind the neck-like housing portion 80. As a result, the suspension element 90 is connected to the neck-like housing portion 80 by means of the snap-fit lugs 96, 97 even during pivoting of the suspension element 90 about the pivot axis.

FIG. 6 is a partial view of the hand-guided tool 10 with the neck-like housing portion 80 and its pivot axis 85. The neck-like housing portion 80 has four latching recesses 81 into which the latching cams 98, 99 of the suspension element 90 engage in each case in different pivot positions of the suspension element 90 about the pivot axis 85. The latching recesses 81 are arranged in pairs opposite one another such that the latching cams 98, 99 engage simultaneously in each case. An angular distance between two adjacent latching recesses 81 is preferably 90°.

The present invention has been described using the example of a nail gun. It should be noted, however, that the invention can also be used in other tools.

1. A hand-held tool comprising a housing having a neck-like housing portion and a suspension element having a connection portion for connecting the suspension element to the neck-like housing portion and having a suspension portion for temporarily suspending the tool on a separate object, wherein the connection portion comprises two spring arms, which enclose the neck-like housing portion on opposite sides in a snap-fit connection to connect the suspension element to the housing.

2. The tool according to claim 1, wherein at least one of the two spring arms has a snap-fit lug which engages behind the neck-like housing portion to produce the snap-fit connection.

3. The tool according to claim 2, wherein the snap-fit lug is arranged on an end of the at least one spring arm pointing away from the suspension portion.

4. The tool according to claim 1, wherein the neck-like housing portion has a peripheral surface which defines a pivot axis, and wherein the suspension element is connected to the housing so as to be able to pivot about the pivot axis.

5. The tool according to claim 4, wherein the neck-like housing portion has a latching recess, and wherein at least one of the two spring arms has a latching cam which engages in the latching recess to lock the suspension element in a pivot position about the pivot axis.

6. The tool according to claim 5, wherein at least one of the spring arms has a snap-fit lug which engages behind the neck-like housing portion to produce the snap-fit connection and, wherein an engagement depth of the latching cam in the latching recess is smaller than a rear engagement depth of the snap-fit lug behind the neck-like housing portion.

7. The tool according to claim 5, wherein the neck-like housing portion has a plurality of latching recesses into which the latching cam engages in different pivot positions of the suspension element about the pivot axis.

8. The tool according to claim 1, wherein the suspension element consists substantially of a plastics material.

9. The tool according to claim 1, wherein the connection portion and the suspension portion are integrally formed.

10. The tool according to claim 1, wherein the housing has a connecting region for an electrochemical accumulator, and wherein the connecting region for the electrochemical accumulator directly adjoins the neck-like housing portion.

11. The tool according to claim 1, wherein the housing has a handle around which fingers of one hand can grip, and wherein the handle includes the neck-like housing portion or directly adjoins the neck-like housing portion.

12. The tool according to claim 10, wherein the housing has a handle, and the neck-like housing portion is arranged between the handle and the connecting region for the electrochemical accumulator.

13. The tool according to claim 1, wherein the tool is a nail gun.

14. The tool according to claim 2, wherein the neck-like housing portion has a peripheral surface which defines a pivot axis, and wherein the suspension element is connected to the housing so as to be able to pivot about the pivot axis.

15. The tool according to claim 3, wherein the neck-like housing portion has a peripheral surface which defines a pivot axis, and wherein the suspension element is connected to the housing so as to be able to pivot about the pivot axis.

16. The tool according to claim 6, wherein the neck-like housing portion has a plurality of latching recesses into which the latching cam engages in different pivot positions of the suspension element about the pivot axis.

17. The tool according to claim 2, wherein the suspension element consists substantially of a plastics material.

18. The tool according to claim 3, wherein the suspension element consists substantially of a plastics material.

19. The tool according to claim 4, wherein the suspension element consists substantially of a plastics material.

20. The tool according to claim 5, wherein the suspension element consists substantially of a plastics material.
